(19) United States
(12) Patent Application Publication
(10) Pub. No.: US 2022/0192114 A1
(43) Pub. Date: Jun. 23, 2022

(54) MODULAR UNIT FOR GROWING CROPS, SYSTEM AND GROW COLUMN THEREOF

(71) Applicant: Invertigro Pty Ltd, Rosebery (AU)

(72) Inventors: Benestine Lee, Millers Point (AU); Todd Eberline, Redfern (AU); Paul Millett, Elanora Heights (AU); Neill Wainwright, Willoughby (AU)

(21) Appl. No.: 17/426,988

(22) PCT Filed: Jan. 30, 2020
(86) PCT No.: PCT/AU2020/050059

§ 371 Date: Jul. 29, 2021

(30) Foreign Application Priority Data
Jan. 30, 2019 (AU) 2019900263
Dec. 23, 2019 (AU) 2019904910

(51) Int. Cl. A01G 31/02; A01G 7/04

(52) U.S. Cl. CPC A01G 31/02; A01G 2031/006; A01G 7/045

(57) ABSTRACT

The present disclosure provides a hydroponic unit (2) and system (1) for growing crops, the unit being modular to allow different containers and growing conditions within the unit, and the system being modular to allow multiple units to share common power and water requirements. The unit and system aim to provide a more efficient and easier to use hydroponic operation. The unit includes an adjustable framework and manifold in each unit for receiving containers of a first or second type, and the system includes a support structure (4) including module bases (3) for each unit and a water control module for the system. Also provided are growing columns for use within the hydroponic unit.

### TECHNICAL FIELD

The present disclosure relates to a modular unit for growing crops through hydroponics or similar means and a grow column for use with the unit, as well as a system for growing crops through hydroponics or similar means including these units.

### BACKGROUND OF THE DISCLOSURE

To meet the demands of a growing world population, the agricultural industry has consistently sought to improve the efficiency of growing edible crops. To this end, numerous modern growing techniques such as hydroponics, aeroponics, and nutrient film technique (NFT) have been developed with the aim of growing crops without the large amount of soil and land required for conventional agriculture. These techniques have resulted in the development of vertical indoor farming, where plants or other crops are grown indoors in vertically stacked layers under artificial lighting. By using the vertical space above the ground, this arrangement further increases the amount of crops that can be grown in a set area compared to conventional farming, and also allows crops to be grown on an industrial scale closer to urban areas. This has the added environmental benefit of reducing the ‘food miles’ travelled to reach the consumer. Indoor farming is also less susceptible to seasonal variation and poor weather conditions, providing a more reliable crop yield than possible through conventional farming.

Despite these benefits, vertical indoor farming has found limited usage, owing mainly to the large cost and complexity of the operating equipment currently available. Commercially available indoor farming systems able to produce crops on a large scale for commercial sale are expensive to install and labour intensive to manage and operate. Further, these systems are often optimized for one specific crop, and are unable to be modified to produce different growing conditions for another crop without substantial effort. The system is thus unable to convert to growing a new crop without significant cost, effort and time to convert the system into a set-up suited to growing the new crop variety.

In the other hand, smaller systems, built into shipping containers or similarly sized units, provide a lower cost alternative, however these systems are difficult to scale up a level large enough to provide commercially viable crop yields as multiple containers on a single site create complexity in harvesting as well as requiring complicated power and water distribution arrangements which are often inefficient. The complexity of harvesting also means that these systems require high amounts of labour, adding to the costs required.

Currently used vertical growing systems, both for small and large scale production, usually rely on grow walls or towers in which the crops are grown in at least one channel containing a suitable media for growing crops. Typically, these channels are either on one face of the wall or tower or on opposing faces. Nutrient-rich water is fed to the crops by drip nozzles arranged over the channels.

The present invention seeks to provide a vertical indoor farming system that solves at least some of these problems by providing a modular system of modular units allowing easily changeable growing conditions as well as efficient scalability from small to commercial scale production. It also seeks to provide more efficient water and power distribution throughout the system and easier planting and harvesting compared to existing vertical growing systems.

### SUMMARY OF THE INVENTION

According to a first aspect, there is provided a unit for growing crops, comprising; a housing, an access point such as blinds or a door located in at least one side of the housing, at least one light integrated into an interior of the housing, at least one container of a first type for growing crops or at least one container of a second type, an adjustable framework within the housing which is adapted to at least partially receive the at least one container of a first type or a second type, wherein said at least one container is removably located, a fluid inlet which allows fluid communication into the interior of the housing from a fluid source remote to the unit, a manifold located in an upper portion of the housing, including a first and second set of outlets, wherein the first set of outlets is capable of directing fluid from the inlet to the at least one container of a first type and the second set of outlets is capable of directing fluid from the inlet to the at least one container of a second type, and a fluid outlet which allows fluid communication from the at least one container out of the interior of the housing.

In certain embodiments of the first aspect, there is no piping between the at least one container of a first or second type and the manifold and/or framework so as to allow said at least one container to be removed and reinserted by a user.

In certain embodiments of the first aspect, the unit further comprises a ventilation system for controlling the flow of air into and out of the unit.

In certain embodiments of the first aspect, the ventilation system includes an air intake located in a lower portion of the housing and an exhaust vent located in an upper portion of the housing on an opposing side of the unit to the air intake.

In certain embodiments of the first aspect, the housing includes: at least one side wall including an internal cavity which is capable of fluid communication with the air intake and an inner surface of the at least one side wall includes a plurality of openings; wherein air enters the unit through the air intake and travels through the internal cavity and the plurality of openings to enter the interior of the housing.

In certain embodiments of the first aspect, the diameter of the openings varies along a vertical direction of the side wall to allow an even flow of air across the interior of the unit.

In certain embodiments of the first aspect, the ventilation system includes blower fans built into the housing.

In certain embodiments of the first aspect, the ventilation system includes a filtering element such as a HEPA filter.

In certain embodiments of the first aspect, the ventilation system can be configured to prevent air exiting the housing.

In certain embodiments of the first aspect, the fluid outlet allows fluid communication with the fluid source to be recycled.

In certain embodiments of the first aspect, the manifold is configured to release water into the at least one container of the first or second type for growing crops solely under gravitational force.

In certain embodiments of the first aspect, the at least one light is an LED.

In certain embodiments of the first aspect, the at least one container of a first type is in the form of a vertically oriented growing column.

In certain embodiments of the first aspect, the at least one vertically oriented growing column can be rotated around its long axis.

In certain embodiments of the first aspect, each of the at least one growing columns comprise at least one stackable segment, each segment including at least one opening in which a pot for growing crops can be removably located.

In certain embodiments of the first aspect, there are a plurality of segments and the segments further include an interior cavity which allows fluid communication between adjacent segments and a channeling element located within the interior cavity which channels fluid towards the at least one opening and pot in the segment.

In certain embodiments of the first aspect, at least one light is in the form of a light column around which a plurality of growing columns are arranged.

In certain embodiments of the first aspect, at least one light is located along at least one inner edge of the interior of the housing, the inner edge being substantially parallel to the at least one growing column.

In certain embodiments of the first aspect, additional lighting elements are provided in the interior sides of the housing.

In certain embodiments of the first aspect, there is a plurality of growing columns, and the growing columns are located on a rotatable carousel including a carousel manifold located above the growing columns and in fluid communication with the columns; wherein the manifold directs fluid into the carousel manifold.

In certain embodiments of the first aspect, the at least one growing column is located around a periphery of the rotatable carousel.

In certain embodiments of the first aspect, the rotatable carousel is motorised.

In certain embodiments of the first aspect, the rotatable carousel includes a set of gear teeth around a lower surface at its periphery, and a motorised worm gear is used to rotate the carousel.

In certain embodiments of the first aspect, the base of each growing column includes gear teeth which interact with the worm gear to cause rotation of the columns when the rotatable carousel moves.

In certain embodiments of the first aspect, the gear at the base of each growing column has a suitable ratio such that each growing column will have different orientations after consecutive full rotations of the carousel.

In certain embodiments of the first aspect, the at least one container of a second type is in the form of a horizontally mounted drawer or tray.

In certain embodiments of the first aspect, the unit further comprises a removable central partition which attaches to the adjustable framework, the central partition being capable of at least partially receiving containers of the second type.

In certain embodiments of the first aspect, each of the at least one horizontally mounted drawers includes an overflow outlet such that the drawer can only be filled with a fluid to a predetermined height and drainage outlets at a bottom surface of the drawer.

In certain embodiments of the first aspect, each of the at least one horizontally mounted drawers includes a light on an underside of the drawer.

In certain embodiments of the first aspect, each of the at least one horizontally mounted drawers includes a removable connection to a busbar located in the housing to allow electrical communication between the busbar and the each horizontally mounted drawer.

In certain embodiments of the first aspect, the horizontally mounted drawers are aligned so that they face at least one of the access points such that an operator can easily add or remove crops from the drawers.

In certain embodiments of the first aspect, the housing includes openings located on at least one exterior surface for receiving forks from a forklift or similar vehicle for transporting the unit.

According to a second aspect, there is provided a modular system for growing crops, comprising at least one grow module, the module comprising: a housing, an access point such as blinds or a door located in at least one side of the housing, at least one light integrated into an interior of the housing, at least one container for growing crops, an adjustable framework within the housing on which the at least one container can be removably located, a fluid inlet which allows fluid communication into the interior of the housing from a water source remote to the module, a manifold located in the housing in fluid communication with the inlet, a fluid outlet which allows fluid communication out of the interior of the housing, a water control module, comprising the water source and a pump, and a support system attached to the at least one module.

In certain embodiments of the second aspect, the grow module is a unit according to the first aspect.

In certain embodiments of the second aspect, the system further comprises at least one stack base unit, comprising a connection to a power source and a pump; wherein the stack base unit is attached to the support system; and wherein fluid and electrical communication is possible between each stack base unit and a plurality of grow modules through the support system

In certain embodiments of the second aspect, the support system contains a plurality of module bases, the module bases shaped to receive the grow module.

In certain embodiments of the second aspect, the support system contains couplings for allowing fluid and electrical communication between the fluid inlet of the grow module and the stack base unit and/or water control module when the grow module is located on the module base.

In certain embodiments of the second aspect, the couplings are in the form of spring loaded valves such that fluid and electrical communication through the coupling is prevented when the grow module is not located on the module base.

In certain embodiments of the second aspect, the stack base unit or grow module includes a transformer to convert mains power to a suitable DC voltage for use by the at least one grow module.

In certain embodiments of the second aspect, the pump in each stack base unit is a positive displacement pump.

In certain embodiments of the second aspect, the pump in the water control module is a positive displacement pump.

In certain embodiments of the second aspect, the water control module includes tanks containing nutrient and pH altering components for maintaining the pH and nutrient composition of water in the water source.

In certain embodiments of the second aspect, the water control module includes a logic control system which takes readings of the electroconductivity and pH level of the water source and adds nutrients or pH altering components based on a predetermined level.

In certain embodiments of the second aspect, the logic control system also transmits scheduling information to the at least one stack base unit for timing pumping water to the grow modules and operating the at least one light within the housing.

In certain embodiments of the second aspect, the support system is arranged so that a plurality of grow modules located in vertically adjacent module bases are fed water and electricity from a single stack base unit located at the bottom of the grow modules.

According to a third aspect, there is provided a grow column for a unit for growing crops, the column comprising a plurality of stacked segments, wherein each segment comprises a first end, a second end, a side wall extending between the first and second end to form a cavity, at least one opening located in the side wall, at least one pot removably located within the opening so that the pot is in fluid communication with the cavity, a channeling element located at the first end, wherein fluid entering the first end is diverted towards the at least one opening, and interlocking connection elements at the first and second ends which couple adjacent segments together; wherein each segment is composed of a plurality of segment walls which connect to form the side wall.

In certain embodiments of the third aspect, the channeling element acts as the interlocking connection element so that the channeling element of a first segment connects the first segment to the second end of a second segment.

According to a fourth aspect, there is provided a unit including at least one growing column according to either 48 or 49, comprising a housing and/or an access point which is transparent or semi-transparent to allow viewing of the at least one growing column.

In certain embodiments of the fourth aspect, the unit further comprises: a pump; a conduit; a fluid outlet; a tank; wherein the fluid outlet is in fluid communication with the tank; and wherein the pump is able to convey fluid from the tank to the at least one growing column through the conduit.

In certain embodiments of the fourth aspect, the at least one growing column is capable of rotation, and wherein a light is provided in an inner edge of the housing. Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE FIGURES

FIG. 1 shows an embodiment of the modular system for growing crops.

FIGS. 2A-C show isometric views of the module base and grow module.

FIG. 3 shows a front view of an embodiment of a grow module and module base with horizontally mounted drawers.

FIG. 4 shows an isometric view of another embodiment of a grow module with horizontally mounted drawers.

FIG. 5 shows a front view of an embodiment of a grow module with vertical grow columns.

FIG. 6 shows an isometric view of another embodiment of a grow module with vertical grow columns and a rotatable base.

FIG. 7 shows an isometric view from above of an embodiment of a rotatable base and vertical grow columns.

FIG. 8 shows an isometric view from below of the embodiment shown in FIG. 7.

FIG. 9 shows an isometric view of an embodiment of a grow column.

FIG. 10 shows an isometric view of an embodiment of a segment of a grow column.

FIG. 11 shows an exploded view of an embodiment of a segment of a grow column.

FIGS. 12A and 12B show further embodiments of variant segments for a grow column.

FIGS. 13A-D show further embodiments of single segment walls for variant segments for a grow column.

FIGS. 14A and 14B show embodiments of a module capable of receiving either vertical grow columns or horizontally mounted drawers.

FIGS. 15A and 15B show cutaway and complete isometric views of a base for a module capable of receiving either vertical grow columns or horizontally mounted drawers.

FIG. 16 shows another embodiment of a grow module for display with a single vertical grow column.

FIG. 17 shows a further embodiment of a grow module for display with two vertical grow columns.

### DETAILED DESCRIPTION

The present invention provides a modular system for growing crops. In some embodiments, the modular system may be used to grow mushrooms or other fungi, in further embodiments, the system may be used to breed insects or other organisms for consumption.

The system comprises grow modules connected to each other via a support system and a water control module. Typically, each system will grow a single type of crop at a time, and a farm or other indoor growing operation may have a number of systems. Multiple systems may be used to grow different crops and/or increase production of the first crop. In some embodiments, the support system may be attached to stack base units which are in turn attached to the grow modules.

The water control module provides water for the system and preferably includes a large holding tank for storing water as well as reservoirs of nutrients and pH altering components. In most situations, the pH altering components will be acidic as water tends to become more basic over time. The water control module includes a logic controller which receives information about the water level, electroconductivity, and pH of the water in the holding tank from sensors and releases nutrients and pH altering components into the holding tank to maintain a predetermined composition. The electroconductivity is measured as it gives an indirect reading of how nutrient rich the water is. In preferred embodiments, this predetermined composition is optimized for the crop being grown. In some embodiments, a library of compositions for a range of crops is stored in a central server or cloud service and transmitted to and stored by the logic controller when selected by an operator. Ideally, the library is constantly updated and revised based on user data using machine learning or other appropriate algorithm. The water control module also includes pumps for passing water either directly to the grow modules or through a series of stack base units, preferably positive displacement pumps such as, but not limited to, peristaltic pumps. Filters, preferably both ultrafiltration filters and UV filters are located between the holding tank and the conduits for communicating the fluid to the modules and/or stack base units.

The water control module further includes a flushing capability to automatically empty and refill the holding tank periodically. This is important both in the event that the water becomes contaminated and in normal usage, as electroconductivity measurements do not take into account the composition of the nutrients in the water and the nutrients are replaced with salts over time.

In some embodiments, stack base units receive water from the water control module into a holding tank. The water is then transferred to the grow modules by pumping it through the support system at predetermined intervals. In preferred embodiments, the water is pumped using positive displacement pumps. The stack base unit is in electrical communication with mains power and includes a transformer which converts factory or mains power to DC to power the lighting, ventilation and any motors in the grow modules. The stack base unit receives scheduling information from the logic controller in the water control module with regards to timing for watering intervals, lighting, motor operation and ventilation. The timings are predetermined to optimize growth of the crop being grown and are preferably stored in the central server and transmitted to the logic controller at the same time as the water composition. The DC power required may vary in different embodiments of the grow modules. Examples of suitable voltages include 24V or 48V DC, though it will be understood that other voltages may also be required in other embodiments.

In other embodiments, the water control module directs water directly to the grow modules without stack base units being present in the system. In these embodiments, the functions of the stack base unit may be assumed partially or in full by the water control module, which may include some of the features of the stack base unit. Alternatively or additionally, the grow modules may include features which partially or totally perform the functions of the stack base unit. For example, some or all of the grow modules may include a transformer and related electrical equipment to allow the conversion of mains power to a suitable voltage and current for use in the grow module.

The support system includes a plurality of module bases. Each module base is shaped to receive a bottom surface of a grow module, and in preferred embodiments includes spring loaded valves through which fluid and electrical communication is possible between a stack base unit and the received grow module. In these embodiments, the valve acts to prevent communication through the module base when the grow module is removed from the base. Advantageously, the support system does not include any pumps or electronics, only acting as a conduit between grow modules and stack base units. Instead, the water is pumped from the water control module or stack base unit (if present) with enough pressure to travel through the support system conduits, and gravitational forces control the movement of water through the modules.

In some embodiments, the module bases are arranged in a grid, with stack base units located underneath the bottom row of module bases. Each stack base unit supplies water and electrical power to the column above it. In some embodiments, it is envisioned that approximately thirty bases are provided in one support system, though it will be understood that in other embodiments, there may be more or fewer module bases supplied.

The grow module contains a housing, containers for growing crops and a manifold. An access point is provided in the housing for an operator to harvest, inspect or plant crops. This access point may be for example a door or blind. In preferred embodiments, the housing is substantially cuboid in shape and the edges of the housing are chamfered or rounded. The manifold is located in an upper portion of the housing above the containers, and receives water pumped from the stack base unit or directly from the water control module through the support system. The manifold then transfers the water to the containers by gravity drip. Drain outlets at a lower portion of the containers allow excess water to be collected and channeled back to the stack base unit and/or water control module for re-use in the system. This is also driven entirely by gravity.

The grow module further includes a ventilation system. Preferably, this system includes an inlet, possibly including a control means such as louvers which can be operated to increase or decrease the flow of air into the system. The inlet may also include a mesh to filter out particulates and prevent pests from entering the system. The ventilation system may further include exhaust fans for allowing air to leave the system. Louvers may also be provided on the exhaust to control the air flow out of the module. In some cases, it may be advantageous to trap air inside the module, such as during germination or when growing mushrooms. In these cases, the ventilation system can be configured to prevent air from leaving the system, the timing of which is controlled by the stack base unit acting on information transmitted from the water control module. In these embodiments, the access point is configured to be airtight.

In preferred embodiments, the module is arranged such that the ventilation inlet is located in a lower part of the housing, below where the containers are located. The inlet allows the intake of air into a chamber below the containers and includes a blower fan which pressurises this lower chamber. In these embodiments, the side walls of the housing are hollow, and the interior cavity of the side walls in fluid connection with the lower chamber. Openings are provided in the interior surface of these side walls so that air travels through the openings and into the main interior of the module where the containers for growing plants are located. The openings may be located such that air travels into the interior of the module at a location beneficial to the crops being grown, such as above each horizontally mounted tray to maximise airflow to the plants being grown. In preferred embodiments, the diameter of the openings is varied such that there is an even airflow across the module, for example by providing openings of larger diameter in a direction away from the air intake source, i.e. for embodiments where the inlet is below the main interior where the containers are located, the diameter of the openings may increase in a vertical direction away from the inlet. It will be understood that the term diameter in this circumstance is used generally, and is intended to refer to the surface area of the openings, rather than any limitations on the particular shape of the openings.

By placing the ventilation intake on a first side, preferably the front facing side where an access point and/or interface is located, and the exhaust on an opposing side, preferably a rear side facing the rack when mounted as part of a system, the system adopts a layout similar to the ‘hot aisle/cold aisle’ approach for data server racks. Much like for server racks, the hot aisle/cold aisle layout conserves energy and reduces the cooling costs, more effectively managing the heat created from the modules than otherwise would be achievable.

Lighting is also located within the interior of the housing. Typically, this will be in the form of LED lighting for heat and power efficiency, and may be located in the middle of the interior or at the corners of the housing depending on the type of container. The interior may also have a reflective interior surface coating to reflect light and maximise growth. In preferred embodiments, the LED lighting is in the form of strips which are able to be removed and replaced by an operator depending on requirements. The LEDs are preferably optimized to provide light spectra adapted for the crop being grown. In embodiments where the containers, preferably vertical growing columns, are rotated while in an interior of the housing, lighting elements may only be required in one or two of the corners as the rotation of the containers allows the crops being grown to be exposed to the same amount of light with a reduced number of required lighting elements. In other embodiments, lighting elements may be provided on the containers, preferably horizontally mounted containers, so as to provide light to adjacent containers.

In some embodiments, the light spectra and intensity of the lighting within the housing may be changeable over time. For example, as plants grow larger, higher light intensity may be required. Plants may also require different light spectra to control growth phases, for instance, a change in light spectra and intensity may cause a plant to begin fruiting. In preferred embodiments, the timing of these aspects is controlled by the water control module. In some embodiments, the water control module receives predetermined timings optimized for the crop being grown from a cloud or other suitable central server.

It will be understood that the containers within the housing may take a number of forms. Preferred embodiments include containers in the form of either horizontally mounted drawers or vertical grow columns. In particularly preferred embodiments, the housing includes a framework which is capable of mounting either form of container. Other embodiments may include different containers suitable for hydroponic growth.

In a preferred form of the containers, the containers are horizontally mounted drawers. The drawers have an overflow outlet located at a side wall of the drawer and drain holes on a bottom surface. The drawers are also filled with a media suitable for growing crops, such as rock wool. These drawers are positioned so that they can slide in a direction facing the access point for easy inspection and harvesting.

In a system containing these drawers, water drips from the manifold into the containers, filling each container up to the level set by the overflow outlet and allowing the water to slowly drain from the containers. Water can flow one container to another, filling all containers in turn. This may be accomplished by either locating the overflow outlet in such a way to flow into containers below the first, by providing a valve assembly in each container capable of stopping the flow of water from the first container to the second while it is being filled and draining it when filling stops, or a combination of the two. This also has the further advantage of allowing a user to remove a drawer from the system without interrupting the flow of water throughout the remaining drawers, as water from a drawer above the removed drawer will instead be directed to the drawer below the removed drawer. Similarly, if the user wishes to add drawers to the system, then water will flow from a drawer above the inserted drawer into the inserted drawer which will in turn fill the drawer below.

In another preferred form of the containers, the containers are vertical grow columns. These columns are connected to the manifold at an upper end and feature a hollow interior space through which water can pass from the manifold. The columns are connected at a lower end to a drain outlet which is fluidly connected to the water control module. The grow columns have openings extending at an acute angle from the long axis of the column in which crops can be located. In some embodiments, these openings are located in protrusions which extend from the body of the column in the same direction as the opening. Preferably, the crops are located in pots which are shaped to be removably mounted in the openings. When an operator wants to harvest the crops, they can simply remove the pots from the openings and replace them with a new pot containing seeds or seedlings. The pots also contain a suitable media for the crop being grown, such as rock wool.

In preferred embodiments, the grow columns are made up of modular segments, each containing at least one opening for growing plants. These segments can be removed individually for cleaning or other maintenance and can be constructed to a range of heights by varying the number of segments. This is advantageous for optimizing the system for different crop types, some of which may require more space to grow.

Modules that include grow columns may also feature a rotating carousel on which the grow columns are located. The rotating carousel may include a base which may be powered by an electric motor off the power supplied by the stack base unit or by another power source. The electric motor may be connected to a worm gear which cooperates with gear teeth along a periphery of the rotating carousel to allow movement. Further gear teeth may be provided around a periphery of each grow column so that the columns are also rotated relative to the carousel. Preferably, the column gear teeth have a different ratio to the carousel teeth so that the column is in a different orientation with each rotation of the carousel. The rotating carousel allows an operator to stand at an access point and rotate the base and columns to reach and harvest every plant from the same location.

The carousel may also include an second open carousel manifold above the growing columns. Fluid (typically water) can be directed into this open carousel manifold when the carousel is installed in the module. The location of the carousel manifold above the columns provides a number of substantial benefits over conventional systems using drip emitters. Firstly, no pumps are required within the module reducing the cost and complexity. Secondly, a problem with the current drip emitters is clogging due to salt build-up over use. This is a problem because the nutrients added to the water contain a lot of salts. By providing a plurality of large diameter outlets which drip into the containers by gravity, the diameter of the inlet into the module can be made far larger than that of the equivalent drip nozzles as the water can flow into the carousel manifold without fear of overwatering the plants. This reduces the incidence of clogging, and careful design of the drip holes in the carousel manifold can also provide a greater range of possible flow rates than possible for drip emitters due to the risk of clogging at certain flow rates. Additionally, the carousel manifold is open so to allow fluid to flow from the stationary manifold into the rotating carousel manifold regardless of the current position of the carousel. The module's manifold thus does not require any physical connections to the carousel or the growing columns.

The rotation of the carousel and columns provide a number of benefits. The rotation provides a sun and shade cycle which results in stronger plant growth as the plants. This also prevents tip burn which occurs when plants grow too close to the lighting. In preferred embodiments, a full rotation of the carousel will take 5 hours, though it will be appreciated that the optimum time may differ depending on the crop being grown. Activation of the motor is controlled from the stack base unit based on scheduling information transmitted from the water control module.

As previously mentioned, preferred embodiments are capable of mounting both horizontally mounted drawers as containers, or vertical growing columns. This may be achieved by creating a housing with common elements to both systems. This may include connection points in the form of notches or channels to attach either a rotatable carousel when installing vertical growing columns or a central partition when installing horizontally mounted drawers. The housing may also include a ventilation/power system common to both types of containers.

The manifold, which may also be referred to as a header or a header tank, is capable of receiving fluid (for example water) from a fluid source external to the module such as through the large holding tank and water control module. Such a manifold may include a first set of outlets which direct fluid towards the rotatable carousel when installed in the module (specifically, the manifold directs fluid to a second carousel manifold above the growing columns) and a second set of outlets which direct fluid to the uppermost horizontally mounted drawers when they are installed in the module. The horizontally mounted drawers may include a valve or valve assembly to direct fluid to a drawer below when a certain amount of fluid has filled the drawer. Each set of outlets may be blocked or otherwise prevented from allowing fluid to pass through when the other type of container is installed. For example, outlets that direct fluid into horizontally mounted drawers may be blocked when installing vertical growing columns in the module and vice versa. As a result, no component in the grow module is required to hold water and water is able to flow into the module, through the manifold to a first or second type of container(s), and then to a common drainage system.

The common drainage system located in a lower region of the housing may collect fluid from the bottommost drawer or the bottom of each growing column and direct it to a drainage outlet. By arranging the manifold, containers and drainage outlet in this manner, it is possible to rely on gravitational force to move water through the module.

One advantage of the system as described is that in a commercial farming operation, numerous systems will be used to grow one or more crops for sale. In contrast to existing growing operations, the water source is decentralized, with each array including its own water control module. This provides protection against pathogens or similar contaminations to the water supply, as if they occurred in conventional systems, the entire crop would be destroyed. Decentralizing the water supply means that in the event of contamination, only one array will be affected.

Another advantage is that each module is designed to be harvested by one operator at one location. In some embodiments, the system is designed for an operator on a scissor lift to position themselves in front of an access point and harvest the crop as previously described. In other embodiments, a forklift or automated guided vehicle is used to remove the module from the support system and bring it to a harvesting location where the operator can harvest and replant as previously described. In larger operations using multiple systems, an operator can easily move from one system to the next following the same procedure.

A further advantage of the system is that the crop being grown can be easily modified. When a crop is harvested, an operator can simply replant a different crop in the containers and change the setting on the water control module to adjust watering and lighting for the new crop. In this way, no major alterations are required to the system when converting to another crop. This is particularly advantageous when changing from one type of growing container to another, where the containers and some internal components may be substituted without totally replacing the unit or system. In the case that the user has a number of modules in the system, each module may be removed and the internal components substituted before placing the module back into the system without disrupting or requiring movement or alteration of the overall system.

The present invention will be better understood by the following non-limiting embodiments.

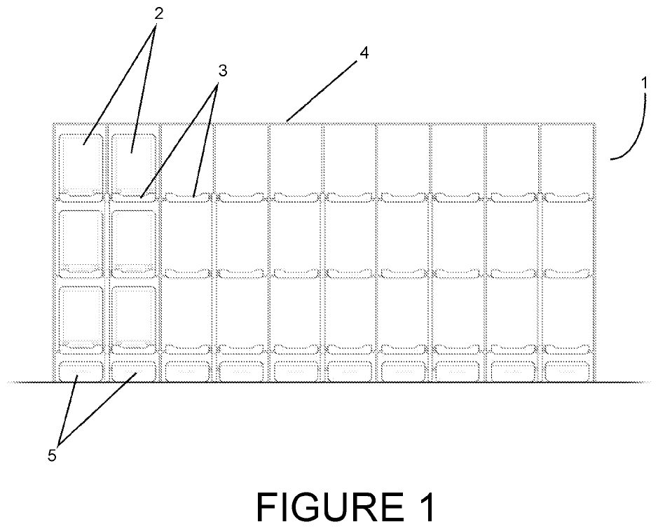

FIG. 1 shows a modular system for growing crops 1, consisting of grow modules 2 located on module bases 3 of support system 4. These grow modules are fed by stack base units 5. Each column of grow modules 2 is fed water and power by the stack base unit 5 located at the base of the column, with each stack base unit 5 receiving water from the water control module (not shown). The stack base units also control the lighting, ventilation, and other growing parameters such as operation of motors within the grow modules. As a result, grow modules 2 can be easily added to or removed from the system by simply placing them on an available module base 3. For example, in this embodiment, the system is capable of holding 30 grow modules in a 10 by 3 grid, but only 6 grow modules have been added. If the user decides to increase their crop, they can easily do so by adding modules to the existing system by placing them on any available module base 3.

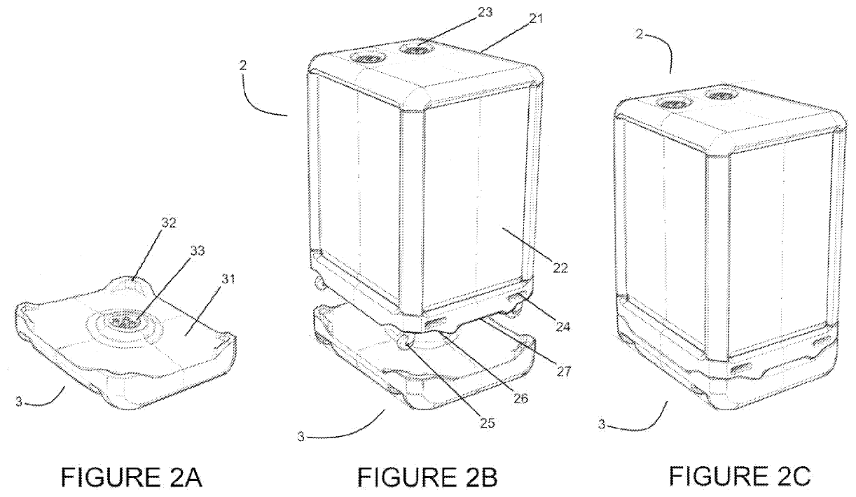

FIGS. 2 A-C show the connection of an embodiment of a module base and grow module.

FIG. 2A shows a module base 3. The module base 3 includes a mating surface 31 on which a grow module can be placed. To ensure the correct location of the grow module over the module base, protrusions 32 extend from the mating surface 31. In this embodiment, these are located at the corners of the mating surface, however it will be understood that in other embodiments, these protrusions may be located elsewhere, or may take the form of slots or other suitable locating elements. A conduit 33 for allowing fluid and electrical communication between the grow module and the module base is located on the mating surface. These conduits contain spring loaded valves which depress so that communication is only possible when a grow module is placed on the mating surface.

FIG. 2B shows a grow module 2 positioned over the base module 3. The grow module includes a substantially cuboid housing 21 with access points in the form of roller blinds 22. Exhaust fans 23 are included in a top surface of the housing and an air inlet is included on a bottom surface (not shown). In this embodiment, the air inlet is in the form of louvers with a mesh or other suitable filter for preventing pests or other harmful organisms from entering the housing. A cavity 27 is created between the grow module and the module base. The air inlet is located on a surface of this cavity so that air can pass through the cavity into the module. The housing also includes recessed portions 26 which align with protrusions 32 of module base 3, locating the grow module in the correct position to allow conduit 33 to align with corresponding conduits within the grow module. The grow module is placed on the base module by a forklift or similar vehicle. To assist in this process, openings 24 are provided in the housing to receive the forks from a forklift or other suitable vehicle. Trolley wheels 25 are also provided to allow easy movement along the ground when not being carried by a vehicle.

FIG. 2C shows the module base and grow module of FIG. 2B in an attached state ready for growing crops.

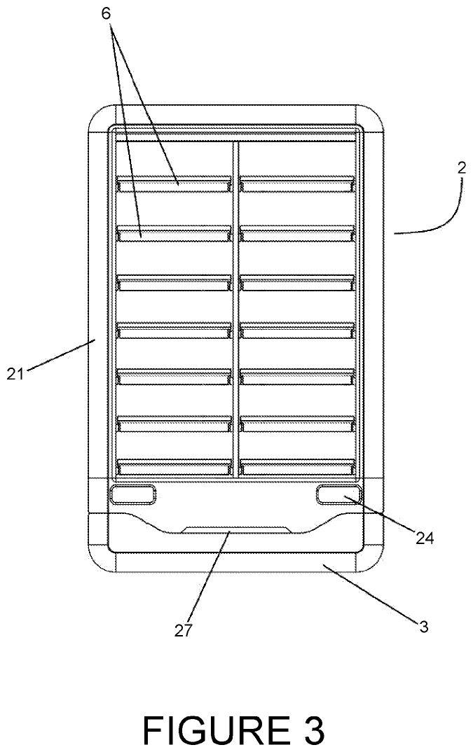

FIG. 3 shows a front view of an embodiment of a grow module 2 on a module base 3 with the access points, such as sliding doors or roller blinds removed to show an interior of the housing 21. In this embodiment, the containers are in the form of horizontally mounted drawers or trays, all of which are of the same size. An operator can easily slide out the drawers in order to plant or harvest crops. Alternatively, at harvesting time, the operator may pre-prepare a number of additional drawers containing seedlings and media and substitute these for the drawers in the module for harvesting. Lights (not shown), preferably in the form of LED strips, are located on at least one of the top and sides of the drawers. In some embodiments, the drawers are designed to have integrated LED strips in an underside of the drawer, where power is supplied to the drawer by means of an electrical PCB including clips which can attach to a bus bar provided in the housing, preferably at the rear of the drawer. Thus, when the drawer must be removed, the user can simply slide the drawer out from the housing, the force of which will cause the clips to detach. In this way, the drawer can be removed without the user having to detach any wiring or plugs from the drawer first. When the user wants to reinsert the drawer, the clips will reattach to the busbar by the force of the user sliding the drawer back into the housing. The PCB may allow degrees of control, that is to say the intensity or number of lights which are turned on for each drawer. The drawer may include a tray or flat which sits in the drawer, the tray including openings in which plants (optionally in pots) can be placed. In this way, light can be blocked from reaching the root zone of the crops being grown. Trays optimised for growing different crops, such as larger openings or greater depth, may also be used, allowing a user to easily swap between trays when changing the crops being grown.

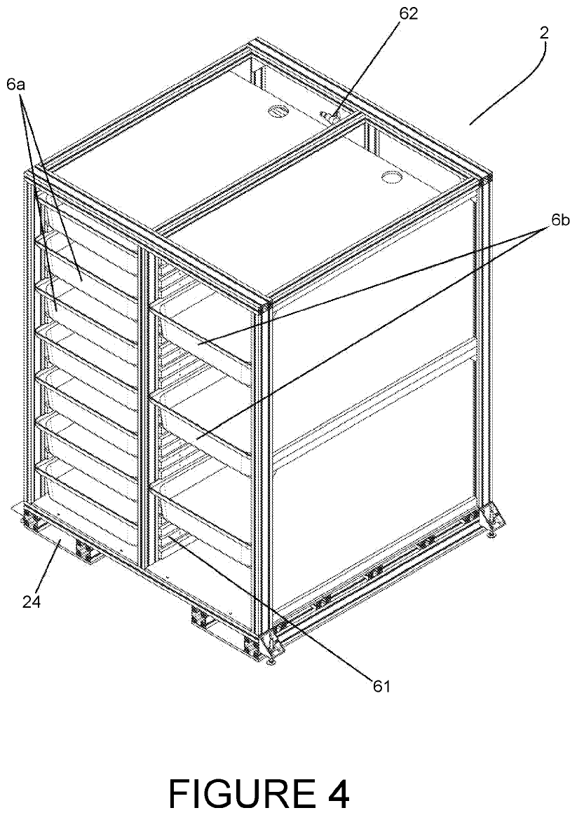

FIG. 4 shows a different embodiment of a grow module 2 with the housing removed. In this embodiment, two different sizes of container are used, a smaller container 6a and a larger container 6b. Both containers can be placed in the housing through a framework 61. Larger containers may be used to grow crops which require more height. Both are fed from the stack base unit via an inlet 62 which feeds water to the drawers. In this embodiment, a flood and drain watering method is used, with each tray being filled to a pre-determined level and allowed to drain through drainage outlets to a central outlet in a lower surface of the housing to be recycled by the stack base unit. The movement of water through the module is entirely driven by gravity, that is to say there are no pumps required within the module. The inlet 62 may in other embodiment be replaced with a manifold, which receives fluid, most commonly water, from the water control module and distributes it to the uppermost drawers. In the embodiment shown in FIG. 4, this would involve distributing water to the uppermost drawers 6a and 6b, which would then convey the water to successive lower drawers by means of an overflow outlet or valve assembly. This avoids the need for physical connections between containers and each other or containers and the module. In preferred embodiments, the manifold has further outlets adapted for another type of container which are blocked when the horizontally mounted drawers are installed. In other embodiments, the stack base units may not be present and instead the containers will be fed directly by the water control module.

In these embodiments, part of the framework may be removable so as to allow alternate framework to be installed, the alternate framework being suited for another type of container. For example, in the embodiment of FIG. 4, the central partition between containers 6a and 6b may be removable to allow the user to install a carousel or other support structure for another type of container. Alternatively, the housing may include a framework which allows another type of container to be added directly into the housing following the removal of the central partition.

Additionally, in some embodiments, the module may include a ventilation system wherein air is brought in through an intake which allows fluid communication with a cavity inside the side walls of the housing. The side walls include openings which allow air flow over the crops being grown. Preferably, the openings are located such that the drawers sit between adjacent rows of openings to maximise air flow over the crops being grown. The central partition is in fluid communication with exhaust openings in the top so that the air flow moves more or less horizontally from the openings in the side walls to the openings in the central partition and out through the exhaust of the module.

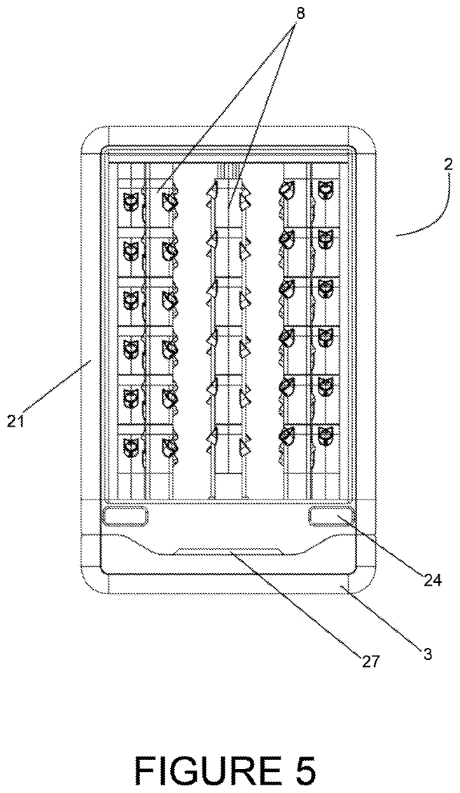

FIG. 5 shows a front view of an embodiment of a grow module 2 on a module base 3 with the roller blind removed to show an interior of the housing 21. In other embodiments, there may be another form of access point, such as double doors instead. In contrast to the embodiment shown in FIG. 2, the containers are in the form of vertical grow columns 8. These columns both are themselves rotatable and are mounted on a rotatable carousel so that an operator can access all the columns and crops while standing at the access point. Lights, preferably in the form of LED strips, may be located along the axis of rotation of the rotatable carousel, along the interior of the housing walls, or a combination of both (not shown).

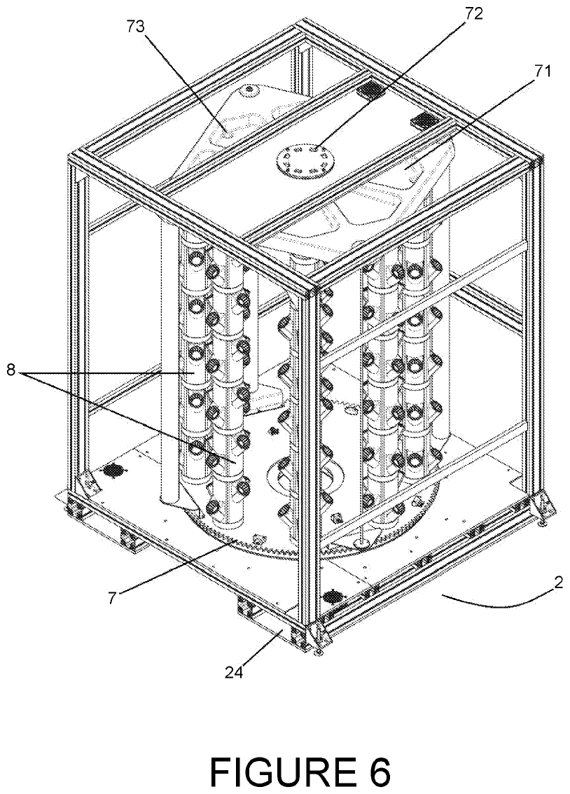

FIG. 6 shows an isometric view of an embodiment of a grow module 2 with containers in the form of rotatable grow columns 8. These grow columns are mounted on a rotatable carousel 7. Nutrient rich water is able to enter the module through inlet 72 which is in fluid connection with a stack base unit or water control module. The inlet 72 is connected to a carousel manifold 71 which is located in an upper location in the housing. Water then passes through column inlets 73 located in the carousel manifold into the grow columns 8. The movement of water through the module is entirely driven by gravity. In other words, there are no pumps in the module. In other embodiments, the inlet 72 may be replaced by a module manifold (not shown) which is capable of directing fluid into carousel manifold 71 in a similar manner. Such a module manifold may also have outlets for directing water towards another type of container, such as the horizontally mounted drawers as seen in FIGS. 3 and 4, which are blocked or otherwise prevented from allowing fluid communication when the rotatable grow columns are installed.

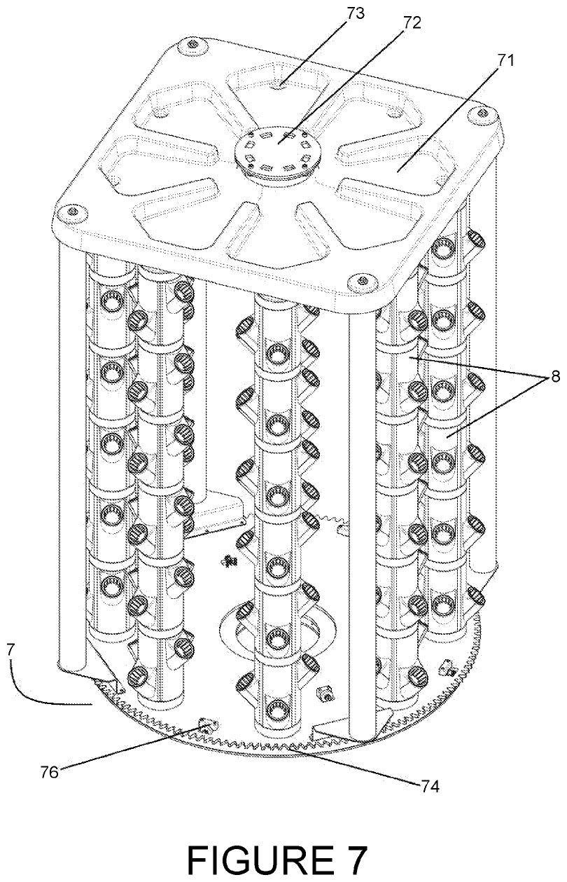

FIG. 7 shows an isometric view of the rotatable carousel 7 of FIG. 6. The carousel manifold 71 and column inlets 73 can be more clearly seen in this view. The carousel manifold is shaped with a central portion in which the inlet 72 opens into, and radial arms which contain column inlets 73 at the distal ends. The rotatable carousel 7 includes a set of gear teeth 74 around the periphery of the carousel and small base bearings or wheels 76 arranged around the base to assist in smooth rotation of the carousel. The growing columns are not attached to the rotatable carousel so that they can easily be disassembled and/or removed by a user. The rotatable carousel may include, for example, a number of channels or recesses shaped to receive grow columns in the base and the growing columns may have a protrusion or flange which corresponds to the openings in the carousel manifold. A user may then simply lift the column and pull it out to remove the column from the housing, without disrupting the remainder of the columns nor requiring the user to remove the carousel or disconnect any conduits or piping from the growing column.

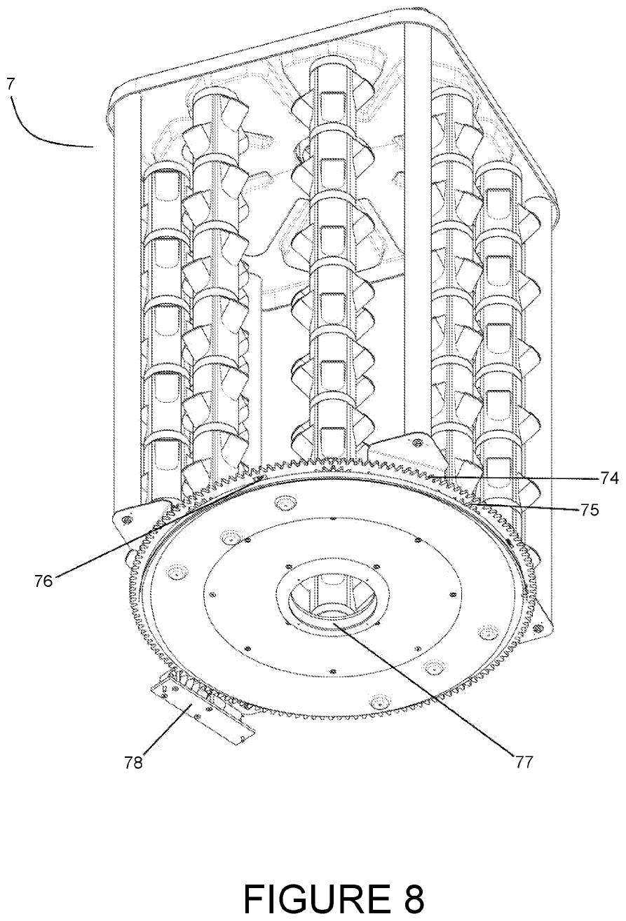

FIG. 8 shows another isometric view of the rotatable carousel 7 of FIG. 6, this time from below. In this view, it can be seen that each column also features a set of gear teeth 75 extending radially from a lower surface of the columns. The carousel and the columns are rotated by a motor attached to a worm gear 78. The column gear teeth 75 have a different gear ratio to carousel gear teeth 74, so that the columns change their orientation with each rotation of the carousel. The motor is driven electrically from a stack base unit or other electrical source. In this embodiment, each rotation will take approximately 5 hours, however it will be understood that in other embodiments, the time to complete a full rotation may be more or less depending on the type of crop being grown. Also clearly visible in this view is the carousel outlet 77, which water flows into from the columns under the influence of gravity. This is in communication with an outlet in the module base and the support system to convey excess water back to the stack base unit or other water source, for example the holding tank and water control module.

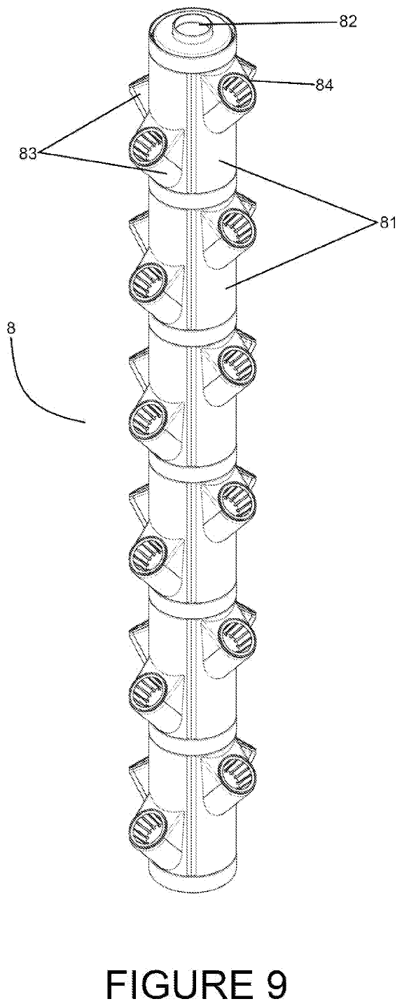

FIG. 9 shows an embodiment of a grow column 8 for use with a grow module. Each column 8 is made up of segments 81. These segments include an inlet 82 and outlet (not shown). The uppermost segment receives water through inlet 82 from a water source such as a reservoir or conduit, and directs it into a hollow interior. The water then passes through the outlet into the inlet 82 of the next segment, where the process repeats until the lowermost column, where water exits the column. Each segment includes protrusions 83 which extend at an acute angle from the long axis of the segment. These protrusions are substantially at right angles to adjacent protrusions, and 4 protrusions are located on each segment, maximising the available room for growing crops. The heights of each protrusion are staggered with respect to adjacent protrusions to maximise the amount of room available for growing plants. Each protrusion also features an opening also angled at the same angle relative to the central axis. These openings are shaped to receive pots 84 for growing plants and to allow fluid communication between the root systems of these plants and the hollow interior of the segment. In this embodiment, the pots contain rock wool as a growing medium. The pots 84 are shaped to be easily removed and replaced. This allows easy harvesting and replanting by an operator compared to existing grow towers or walls, as the grow column does not need to be removed during harvesting. Instead, the operator can simply stand at the door or other access point, removing and replacing each pot of the columns, rotating the columns and base as required. The operator may also remove the columns for replacement or cleaning by lifting the columns out from the housing.

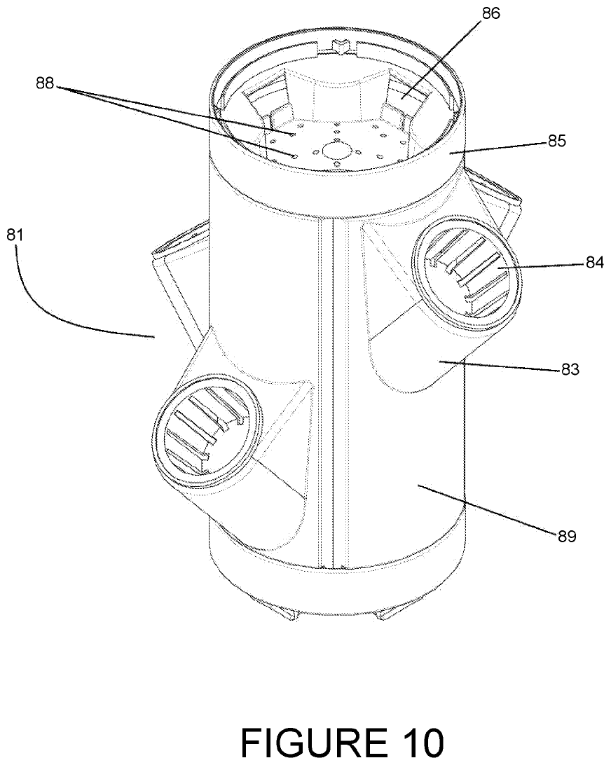

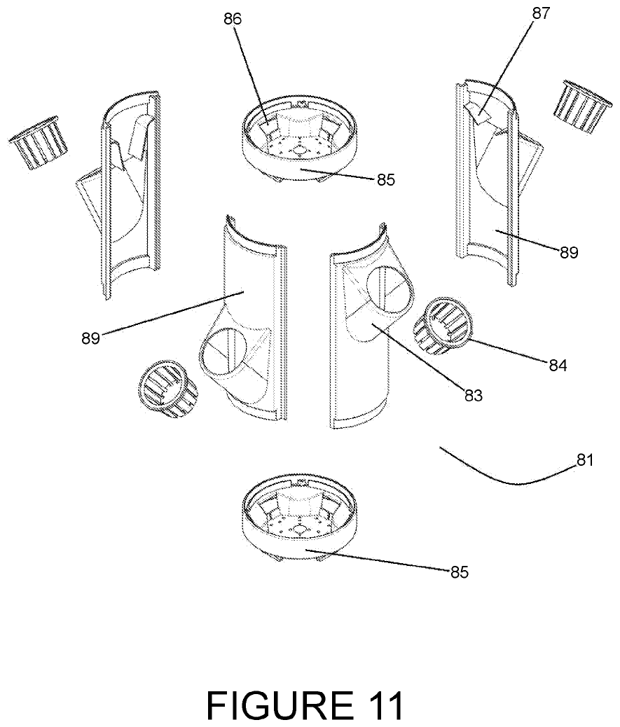

FIGS. 10 and 11 show a single segment 81 of a grow column in an assembled and exploded view. In this view, it can be clearly seen that each segment is made of four segment walls 89, each including a singular protrusion 83 and pot 84. These walls are held together by end member 85, which also acts as a flow channeling element, as well as interlocking elements between segment walls. By providing separate segment walls, the columns may be ‘flat-packed’ or otherwise shipped in a compact form. It may also be possible for different segment walls to be combined to change the number and shape of protrusions and pots. The end member 85 is in the form of a disc with drainage holes 88 and openings 86 which preferentially direct water into channel members 87. These channel members are located on the interior of each wall 89 above the protrusion 83 and associated opening. In this way, water is directed towards the crops growing in pots 84. Excess water then moves under the force of gravity to a second end member 85 at the bottom of the segment. The second end member of this segment is the first end member of segment below.

The rotation of these growing columns is advantageous because it allows the crops being grown to receive the required amount of light with a reduced number of required light sources relative to systems where the columns are stationary. In this way, the heat generated by the light sources inside the module and hence the required power (including for cooling the module) is reduced.

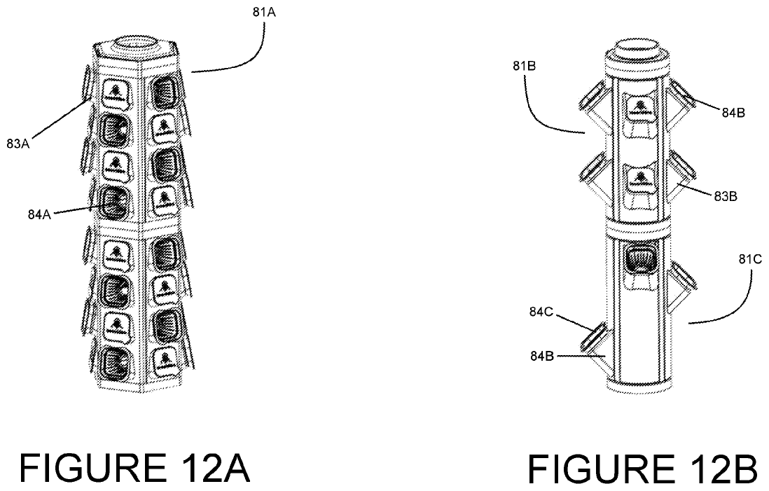

The segments may vary depending on which crops the column is optimised for. FIGS. 12A and 12B show different embodiments of these segments. FIG. 12A shows a hexagonal column made of segments 81A. Each segment 81A is comprised of flat panels with four protrusions 83A including pots 84A in a line. A single segment 81A includes three segment walls each comprising two panels and eight protrusions 83A. The protrusions 83A are less pronounced than those of the embodiment shown in FIGS. 10 and 11. A single module made up of a plurality of hexagonal columns may grow, in an example embodiment, 1152 heads of lettuce.

FIG. 12B shows two separate types of segments 81B and 81C which have been attached to each other to show the flexibility of the growing columns. Segment 81C is similar to the embodiments shown in FIGS. 10 and 11, except that the protrusion 83C is shaped to receive a square shaped pot 84C. Segment 81B includes two protrusions on each panel but is otherwise similar to segment 81C. Both segments 81B and 81C are composed of four curved panels which connect to form a cylindrical segment. A module including columns made of segments 81B or 81C are able to, in an example embodiment, grow 384 or 192 heads respectively. By providing a number of these different columns, it is possible to tailor the grow columns to optimise the hydroponic processes, such as to maximise growth or to account for larger sized crops.

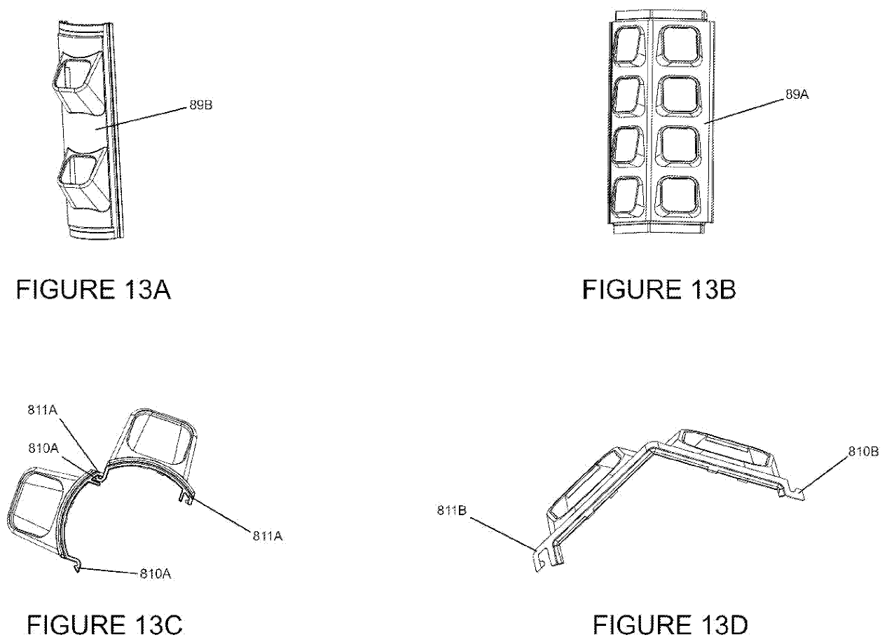

Views of the embodiment of segment wall 89B as shown in FIG. 12B are shown in FIGS. 13A and 13C. FIG. 13C shows two segment walls which each have a first connecting element 810A and a second connecting element 811A on opposing edges so that the first and second connecting elements of adjacent segment walls are able to attach the segment walls together. 810A is in the form of a hook-shaped extension and protrusion and 811A is shaped to receive element 810A, including a protrusion which locks with a corresponding protrusion on 810A. FIGS. 13B and 13D show a segment wall 89A as shown in FIG. 12A. This segment wall 89A has similar connecting members 810A and 811B as the other embodiments shown in FIG. 13C.

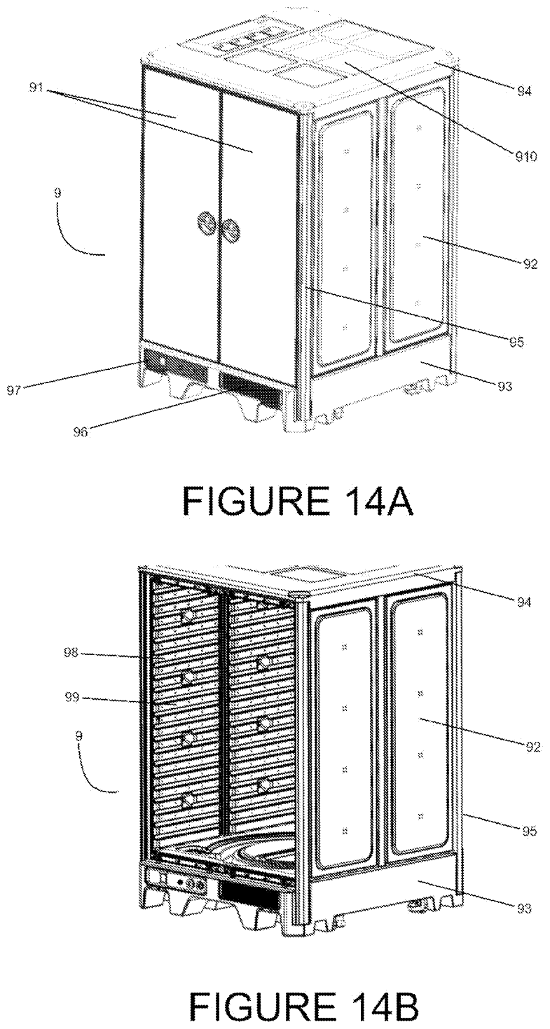

As previously discussed, one possible advantageous feature is to provide a module capable of being converted between one type of container and another. In these embodiments, a large number of elements will be common to both configurations. One such module, with the containers removed, is shown in FIGS. 14A and 14B. The module 9 is comprised of an access point in the form of double doors 91, side walls 92 (only one shown in FIG. 14A), a rear wall (not shown), module base 93 and module top 94. Each of these components may be disassembled and flat-packed for delivery/transport. In this embodiment, the double doors 91 open sideways to allow access to the crops being grown. When assembled, the module base 93 and top 94 have attachment points for corner pieces 95 which hold the side walls 92 in place. The module base 93 and module top 94 may also include connections for the side walls.

The module base 92 is hollow, and includes an air intake 96 as well as an interface panel 97. The interface panel may be used to control the operation of the module and may also include a drainage outlet for situations where the module is not used as part of a larger system. The module base may also include spaces for at least one electrical box to facilitate electrical communication with the interior of the module. The air intake 96 may include a blower fan to bring air into the hollow interior of the module base 93.

The side walls 92 are hollow, and have openings on a lower edge which correspond with openings in the module base 93 so air which is brought into the module base 93 travels into the hollow interior of the side walls. The blower fans pressurise the hollow of the module base so that air is forced to travel into the hollow interior of the side walls. An inner surface of the side walls 98 include small openings 99 through which air travels into the main interior of the module where crops can be grown. The inner surface also includes on the inwards facing side tracks or substantially horizontal protrusions to receive horizontally mounted drawers or similar within the module. The openings 99 in the side walls vary in size in a vertical direction so that openings closer to the module top 94 are larger than those closer to the module base 93. In this way, an even air flow is produced into the interior of the module throughout the entire height of the interior of the module. The module top 94 is also hollow and includes an exhaust on an opposing side of the module and openings in a surface facing the interior of the module so that air travels from the interior of the module through the module top 94 and out of the exhaust.

In some embodiments, the side and rear walls 92 are vacuum moulded and the corner pieces 95 are made of aluminium. In some embodiments, the corner pieces also hold up the module top 94. In further embodiments, the side walls 92 may in fact be comprised of two separate walls sandwiched together so as to form a hollow interior when assembled as part of the module. The module top 94 may also include further electrical boxes and/or access panels 910 to allow maintenance of the module.

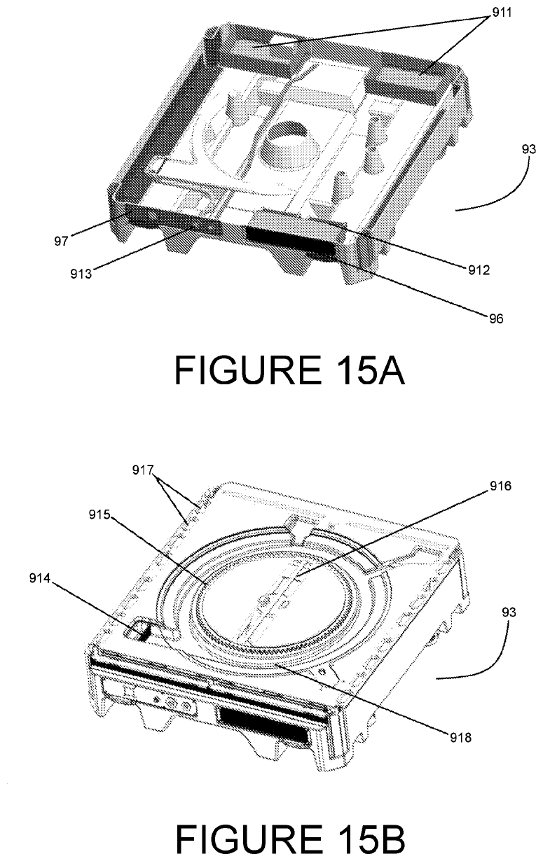

A cross-sectional isometric view and an isometric view of an embodiment of a module base 93 are shown in FIGS. 15A and 15B respectively. In FIG. 15A, it is possible to see that the air intake 96 is attached to a filter and blower fan assembly 912 through which air can pass through and be filtered towards an interior of the module base 93. In this view, it is also possible to see that the interface panel 97 includes a drainage outlet 913 which attaches to a conduit. The module base also includes spaces for electrical boxes 911.

In FIG. 15B, it is possible to see a drainage channel 918 which terminates at a terminal channel 914. This drainage channel 914 connects to the conduit and to drainage outlet 913 as shown in FIG. 15A. The base also includes a series of moulded teeth 915 to which a rotating carousel can be mounted when installing vertical growing columns. The carousel assembly may include a worm drive or similar which uses the moulded teeth to rotate the carousel. The base also includes a connection point 916 for attaching a central partition when installing horizontally mounted drawers. In this manner, a user can convert the module between the two types of containers by adding/removing a rotatable carousel or central partition. In this view, it is also possible to see openings 917 which connect the cavity of the module base 93 to the hollow interior of the side walls (not shown) to allow air to travel from the module base to the side walls and through to the interior of the module.

In some circumstances, users may like to use growing modules to both grow crops but also or alternatively as a display or decoration. In other cases, users may desire to grow crops on a smaller scale than in the previous embodiments. To meet these needs, alternative embodiments optimized for these cases are also envisioned.

Some of these embodiments may include a unit with a cuboid shape which is longer in height than in width or depth. The cross-sectional area in the horizontal plane is relatively smaller than in the previously described embodiments, and so may include fewer containers relative to the previous embodiments (or may include a single container). In some embodiments, a tank may be located below the container(s). The tank is connected to a pump which is able to convey liquid to an upper portion of the unit in fluid communication with the container(s). Unlike the other embodiments, the door and part of the housing around the growing column may be transparent, and may be made of glass or any other suitable material. This allows users to inspect or otherwise view the crops being grown. In these embodiments, lighting may be provided in a substantially vertical direction along at least one inner side or edge of the housing.

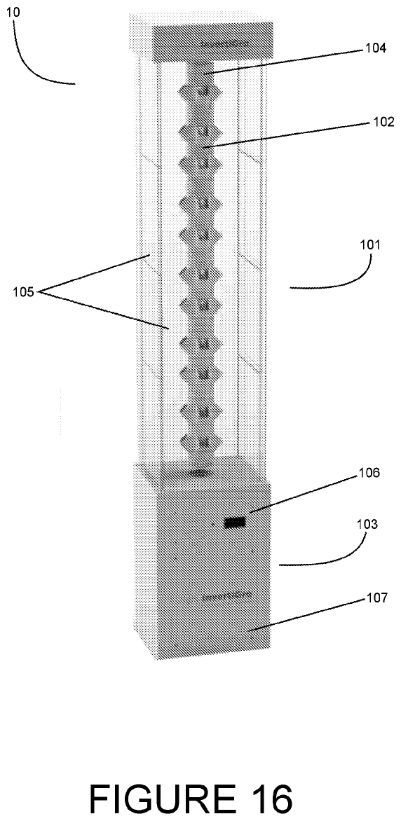

One such embodiment is shown in FIG. 16. The unit 10 has a cuboid shape, including two separate chambers, a first or upper chamber 101 including a growing column 102 capable of rotation and a second or lower chamber 103 containing both the machinery required to rotate the growing column as well as a tank for storing fluid (in this embodiment, water) and the pump, not shown in this figure. The growing column 102 is made of stackable segments of a similar configuration to that shown in FIGS. 9 to 11, though in this embodiment, the protrusions are at the same height in each segment. It will be understood that any of the possible growing column embodiments previously discussed will also be suitable for use in the present embodiment. Also not shown is a conduit which allows fluid communication between the tank and the interior of an uppermost segment 104 of the growing column 102. The interior of the growing column is also in fluid communication with the tank so that water may be recycled. Water is thus able to be pumped to the top of the interior of the growing column from the tank, whereby it flows under the force of gravity through the column, providing nutrients to the crops being grown, and returns to the tank to repeat the process. The lower chamber may also include equipment to measure and/or alter the nutrient content of the water in the tank. Further, the embodiment shown includes a ventilation system with a blower, creating a hygienic environment within at least the first or upper chamber 101.

The side walls 105 which surround the first or upper chamber 101 are transparent or at least partially transparent to allow viewing of the plants. In some embodiments, one of these side walls may include or comprise a door or other access point. These side walls enclose the upper chamber so that the ventilation system can maintain a hygienic environment. At least one side wall in the second or lower chamber may include switches, buttons, or other controls in the form of a control panel 106 for altering at least one of the speed of rotation of the growing column, the water module/pump timing, ventilation parameters, lighting conditions, or other variables related to the growing conditions for the crops being grown. The lower chamber may also include a second access point 107 for maintenance or replacement of the interior components. The lighting (not shown) may be provided in the form of an LED strip along an inner edge of the first or upper chamber. The rotation of the column allows crops being grown around the column to receive the same amount of lighting from this strip. It will be understood that in other embodiments, different lighting arrangements may be used.

Further, it is envisioned that multiple of these units may be brought together to form a wall or display. In these cases, it is envisioned that one of the units may be designated a ‘master’ and connections made between the timing and control circuits of each unit so that changes made to the growing conditions (such as, but not limited to the pump timing, ventilation parameters, rotation speed, lighting conditions) on this master unit will also be applied to the remaining units.

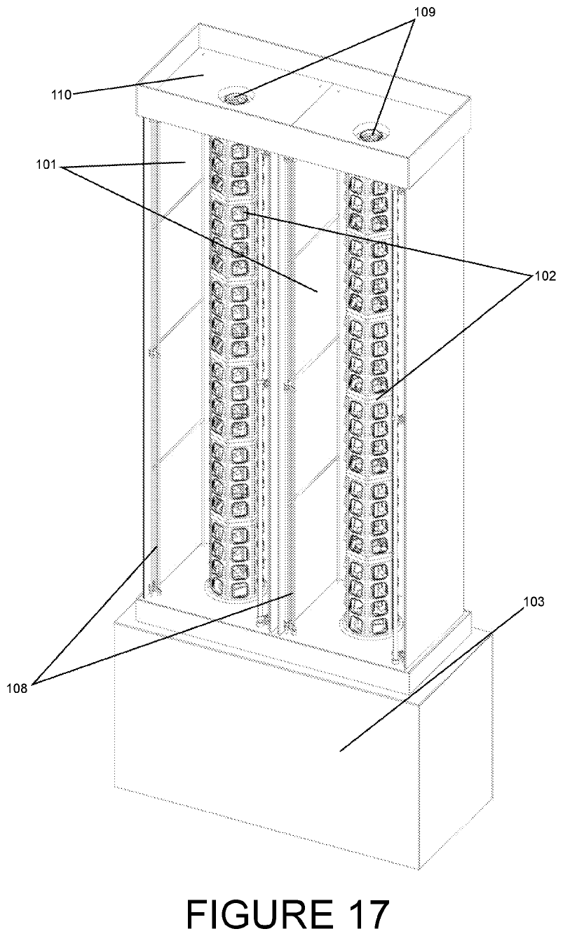

An isometric view of a further embodiment is shown in FIG. 17. In this embodiment, there are two upper chambers 101, each holding a single growing column 102. It will be noted that a growing column similar to that shown in FIG. 12B is shown in this figure, though it will be understood that this column may similarly be removed and replaced with another embodiment of a growing column depending on the type or amount of crop being grown. These chambers are substantially similar to those discussed in relation to FIG. 16. In this figure, the lighting 108 can be seen, extending down an inner edge between two corners of each upper chamber. This embodiment may be formed by joining two embodiments as shown in FIG. 16 together, designating one as a master unit, or by providing a common lower chamber under the two upper chambers 101. In either case, a further layer of housing may be provided around the bases to create a single movable unit. Further, the embodiment shown in FIG. 17 is shown with the top of the unit removed so as to show the column inlets 109 and manifold 110. Water may be directed into the manifold through any known means, preferably from a tank located in a lower chamber 103 to the manifold, where it will flow under gravitational force into the growing columns and drain back to the lower chamber, where it can be recycled for further use or directed out of the unit (for example into an existing drainage system).

Unlike other display hydroponic systems, the container for growing crops, preferably in the form of one or two growing columns, is enclosed within the housing so that ventilation and air flow can be controlled. This is not typically used for display systems as the light requirements of the plants being grown (in particular in lobbies or other similar indoor display environments) necessitates having the plants open to the environment. This is avoided in some embodiments by providing rotating columns and a light source, preferably an LED strip in an inner edge of the housing adjacent the rotating column, to provide the required amount of light. By providing greater control over the ventilation and air flow, healthier and/or more aesthetically pleasing plants may be grown in the display system. Further, the closed system provides a more hygienic growing environment for the crops relative to existing systems with an open system. Further, this may reduce or prevent insects, for example aphids or flies, from entering the system and damaging or reducing the visual quality of the plants.

The vertical columns can be adapted for different crops such as hops or tomatoes through minor alterations. For example, lattices may be provided above each protrusion to assist in growing. Conversely, the protrusions may be provided only on an upper segment so that vines may grow down from the protrusions. In other embodiments, the crops may be plants or flowers chosen for their pleasing aesthetic qualities, rather than those for consumption or sale.

In this specification, the word ‘crop’ is intended to convey a vast number of growable products and should not be seen to limit the use of the invention to any specific plant or species. The term ‘crop’ may refer to plants, fungi or other organisms used for a variety of purposes such as for human or animal consumption or production of pharmaceutical or other vendible products.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### LIST OF PARTS

1 Modular system for growing crops
2 Grow module
21 Module housing
22 Roller blind
23 Exhaust fan
24 Forklift opening
25 Trolley wheel
26 Locating recessed portion
27 Cavity for air intake
3 Module base
31 Mating surface
32 Locating protrusion
33 Fluid and electrical energy conduit
4 Support system
5 Stack base unit
6 Horizontally mounted drawer
6a Small sized horizontally mounted drawer
6b Large sized horizontally mounted drawer
61 Mounting racks
62 Water nozzle
7 Rotatable carousel
71 Carousel manifold
72 Module inlet
73 Column inlet
74 Rotatable carousel gear teeth
75 Column base gear teeth
76 Carousel bearing or wheel
77 Carousel outlet
78 Motor and worm gear
8 Vertical growing column
81 Column segment
82 Column inlet
83 Protrusion
84 Growing pot
85 Fluid channeling element
86 Fluid channeling element opening
87 Segment wall channeling element
88 Fluid channeling element drainage holes
89 Segment wall
810 First connecting element
811 Second connecting element
9 Convertible module
91 Access point (doors)
92 Side walls
93 Module base
94 Module top
95 Corner piece
96 Air intake
97 Interface panel
98 Interior surface of side wall
99 Openings in side wall
910 Access panel
911 Electrical boxes
912 Filter and blower fan assembly
913 Drainage outlet
914 Terminal drainage channel
915 Moulded teeth
916 Connection point for central partition
917 Openings for airflow
918 Drainage channel
10 Single column unit
101 Upper chamber
102 Vertical growing column
103 Lower chamber
104 Uppermost segment
105 Transparent side walls
106 Control panel
107 Second access point
108 Lighting strip
109 Column inlet
110 Header

1. A unit for growing crops, comprising;
a housing,
an access point such as blinds or a door located in at least one side of the housing,
at least one light integrated into an interior of the housing,
at least one container of a first type for growing crops or at least one container of a second type,
an adjustable framework within the housing which is adapted to at least partially receive the at least one container of a first type or a second type, wherein said at least one container is removably located,
a fluid inlet which allows fluid communication into the interior of the housing from a fluid source remote to the unit,
a manifold located in an upper portion of the housing, including a first and second set of outlets, wherein the first set of outlets is capable of directing fluid from the inlet to the at least one container of a first type and the second set of outlets is capable of directing fluid from the inlet to the at least one container of a second type, and
a fluid outlet which allows fluid communication from the at least one container out of the interior of the housing.

2. The unit of claim 1, wherein there is no piping between the at least one container of a first or second type and the manifold and/or framework so as to allow said at least one container to be removed and reinserted by a user.

3. The unit according to either claim 1 or 2, further comprising a ventilation system for controlling the flow of air into and out of the unit.

4. The unit according to claim 3, wherein the ventilation system includes an air intake located in a lower portion of the housing and an exhaust vent located in an upper portion of the housing on an opposing side of the unit to the air intake.

5. The unit according to claim 4, wherein the housing includes:
at least one side wall including an internal cavity which is capable of fluid communication with the air intake and an inner surface of the at least one side wall includes a plurality of openings;
wherein air enters the unit through the air intake and travels through the internal cavity and the plurality of openings to enter the interior of the housing.

6. The unit according to claim 5, wherein the diameter of the openings varies along a vertical direction of the side wall to allow an even flow of air across the interior of the unit.

7. The unit according to any one of claims 3 to 6, wherein the ventilation system includes blower fans built into the housing.

8. The unit according to any one of claims 3 to 7, wherein the ventilation system includes a filtering element such as a HEPA filter.

9. The unit according to any one of claims 3 to 8, wherein the ventilation system can be configured to prevent air exiting the housing.

10. The unit according to any one of the preceding claims, wherein the fluid outlet allows fluid communication with the fluid source to be recycled.

11. The unit according to any one of the preceding claims, wherein the manifold is configured to release water into the at least one container of the first or second type for growing crops solely under gravitational force.

12. The unit according to any one of the preceding claims, wherein the at least one light is an LED.

13. The unit according to any one of the preceding claims, wherein the at least one container of a first type is in the form of a vertically oriented growing column.

14. The unit according to claim 13, wherein the at least one vertically oriented growing column can be rotated around its long axis.

15. The unit according to either claim 13 or 14, wherein each of the at least one growing columns comprise at least one stackable segment, each segment including at least one opening in which a pot for growing crops can be removably located.

16. The unit according to claim 15, wherein there are a plurality of segments and the segments further include an interior cavity which allows fluid communication between adjacent segments and a channeling element located within the interior cavity which channels fluid towards the at least one opening and pot in the segment.

17. The unit according to any one of claims 13 to 16, wherein at least one light is in the form of a light column around which a plurality of growing columns are arranged.

18. The unit according to any one of claims 13 to 17, wherein at least one light is located along at least one inner edge of the interior of the housing, the inner edge being substantially parallel to the at least one growing column.

19. The unit according to either claim 17 or 18, wherein additional lighting elements are provided in the interior sides of the housing.

20. The unit according to any one of claims 13 to 19, wherein there is a plurality of growing columns, and the growing columns are located on a rotatable carousel including a carousel manifold located above the growing columns and in fluid communication with the columns;
wherein the manifold directs fluid into the carousel manifold.

21. The unit according to claim 20, wherein the at least one growing column is located around a periphery of the rotatable carousel.

22. The unit according to either claim 20 or 21, wherein the rotatable carousel is motorised.

23. The unit according to claim 22, wherein the rotatable carousel includes a set of gear teeth around a lower surface at its periphery, and a motorised worm gear is used to rotate the carousel.

24. The unit according to claim 23, wherein the base of each growing column includes gear teeth which interact with the worm gear to cause rotation of the columns when the rotatable carousel moves.

25. The unit according to claim 24, wherein the gear at the base of each growing column has a suitable ratio such that each growing column will have different orientations after consecutive full rotations of the carousel.

26. The unit according to any one of the preceding claims, wherein the at least one container of a second type is in the form of a horizontally mounted drawer or tray.

27. The unit according to claim 26, wherein the unit further comprises a removable central partition which attaches to the adjustable framework, the central partition being capable of at least partially receiving containers of the second type.

28. The unit according to either claim 26 or 27, wherein each of the at least one horizontally mounted drawers includes an overflow outlet such that the drawer can only be filled with a fluid to a predetermined height and drainage outlets at a bottom surface of the drawer.

29. The unit according to any one of claims 26 to 28, wherein each of the at least one horizontally mounted drawers includes a light on an underside of the drawer.

30. The unit according to claim 29, wherein each of the at least one horizontally mounted drawers includes a removable connection to a busbar located in the housing to allow electrical communication between the busbar and the each horizontally mounted drawer.

31. The unit according to claims 26 to 30, wherein the horizontally mounted drawers are aligned so that they face at least one of the access points such that an operator can easily add or remove crops from the drawers.

32. The unit according to any one of the preceding claims, wherein the housing includes openings located on at least one exterior surface for receiving forks from a forklift or similar vehicle for transporting the unit.

33. A modular system for growing crops, comprising
at least one grow module, the module comprising:
a housing,
an access point such as blinds or a door located in at least one side of the housing,
at least one light integrated into an interior of the housing,
at least one container for growing crops,
an adjustable framework within the housing on which the at least one container can be removably located,
a fluid inlet which allows fluid communication into the interior of the housing from a water source remote to the module,
a manifold located in the housing in fluid communication with the inlet,
a fluid outlet which allows fluid communication out of the interior of the housing,
a water control module, comprising the water source and a pump, and
a support system attached to the at least one module.

34. The modular system according to claim 33, wherein the grow module is a unit according to any one of claims 1 to 32.

35. The modular system according to either claim 33 or 34, further comprising at least one stack base unit, comprising a connection to a power source and a pump;
wherein the stack base unit is attached to the support system; and
wherein fluid and electrical communication is possible between each stack base unit and a plurality of grow modules through the support system

36. The modular system according to any one of claims 33 to 35, wherein the support system contains a plurality of module bases, the module bases shaped to receive the grow module.

37. The modular system according to claim 36, wherein the support system contains couplings for allowing fluid and electrical communication between the fluid inlet of the grow module and the stack base unit and/or water control module when the grow module is located on the module base.

38. The modular system according to claim 37, wherein the couplings are in the form of spring loaded valves such that fluid and electrical communication through the coupling is prevented when the grow module is not located on the module base.

39. The modular system according to any one of claims 33 to 38, wherein the stack base unit or grow module includes a transformer to convert mains power to a suitable DC voltage for use by the at least one grow module.

40. The modular system according to any one of claims 34 to 39, wherein the pump in each stack base unit is a positive displacement pump.

41. The modular system according to any one of claims 33 to 40, wherein the pump in the water control module is a positive displacement pump.

42. The modular system according to any one of claims 33 to 41, wherein the water control module includes tanks containing nutrient and pH altering components for maintaining the pH and nutrient composition of water in the water source.

43. The modular system according to claim 42, wherein the water control module includes a logic control system which takes readings of the electroconductivity and pH level of the water source and adds nutrients or pH altering components based on a predetermined level.

44. The modular system according to claim 43, wherein the logic control system also transmits scheduling information to the at least one stack base unit for timing pumping water to the grow modules and operating the at least one light within the housing.

45. The modular system according to any one of claims 34 to 44, wherein the support system is arranged so that a plurality of grow modules located in vertically adjacent module bases are fed water and electricity from a single stack base unit located at the bottom of the grow modules.

46. A grow column for a unit for growing crops, the column comprising
a plurality of stacked segments, wherein each segment comprises
a first end,
a second end,
a side wall extending between the first and second end to form a cavity,
at least one opening located in the side wall,
at least one pot removably located within the opening so that the pot is in fluid communication with the cavity,
a channeling element located at the first end, wherein fluid entering the first end is diverted towards the at least one opening, and
interlocking connection elements at the first and second ends which couple adjacent segments together;
wherein each segment is composed of a plurality of segment walls which connect to form the side wall.

47. The grow column according to claim 46, wherein the channeling element acts as the interlocking connection element so that the channeling element of a first segment connects the first segment to the second end of a second segment.

48. A unit including at least one growing column according to either 46 or 47, comprising a housing and/or an access point which is transparent or semi-transparent to allow viewing of the at least one growing column.

49. The unit according to claim 48, further comprising:
a pump;
a conduit;
a fluid outlet;
a tank;
wherein the fluid outlet is in fluid communication with the tank; and
wherein the pump is able to convey fluid from the tank to the at least one growing column through the conduit.

50. The unit according to either claim 48 or 49, wherein the at least one growing column is capable of rotation, and wherein a light is provided in an inner edge of the housing.
